(19) United States
(12) Patent Application Publication
(10) Pub. No.: US 2014/0254557 A1
(43) Pub. Date: Sep. 11, 2014

(54) MOBILE COMMUNICATION SYSTEM AND CONTENT PROVISION METHOD IN MOBILE COMMUNICATION SYSTEM

(71) Applicants: Sang-Jin KIM, Suwon-si, Gyeonggi-do (KR); SAMSUNG ELECTRONICS CO., LTD., Suwon-si, Gyeonggi-do (KR)

(72) Inventors: Jung Hwan Lim, Suwon-si (KR); Sang Jun Moon, Seoul (KR); Yong Seok Park, Seoul (KR); Jiangwei Xu, Suwon-si (KR); Chul Ki Lee, Seoul (KR)

(21) Appl. No.: 14/349,225

(22) PCT Filed: Nov. 8, 2012
(86) PCT No.: PCT/KR2012/009400

§ 371 Date: Apr. 2, 2014

(30) Foreign Application Priority Data
Nov. 8, 2011 (KR) 10-2011-0115843

(51) Int. Cl. H04W 36/00

(52) U.S. Cl. CPC H04W 36/0011; H04W 88/02
USPC 370/331

(57) ABSTRACT

A handover method at a source eNB (enhanced Node B) of a mobile communication system is provided. The method includes, in case a request message for providing content is received from UE (User Equipment), checking whether the content is stored in a cache thereof, and therefore transmitting the content to the UE, in case a handover request message is received from the UE, transmitting a content confirmation request message, which requests confirmation of whether the content is stored in a cache, to a target eNB to which the UE is to be handed over, and in case a content confirmation response message is received from the target eNB, transmitting context information, which is information about contents offered to the UE, to the target eNB.

### TECHNICAL FIELD

The present invention relates to a mobile communication system and content providing method in the system, and particularly, to a mobile communication system and method for providing contents seamlessly to user equipment in case of handover between LTE eNBs constituting the system.

### BACKGROUND ART

A handover scheme in UMTS and LTE which are 3GPP standard protocols is inefficient due to a loss of data downloaded to or uploaded from user equipment and retransmission of such data.

In order to supplement this inefficient scheme, a device referred to as AME (Application Mobility-management Entity) is added to a mobile communication network such as UMTS and LTE. AME is located at any place between elements that constitute a mobile communication network such as UMTS and LTE. Namely, AME may be located between RNC (Radio Network Controller) and SGSN (Serving GPRS Support Node), between SGSN and GGSN (GPRS Core Network), between eNB and S-GW (Serving GateWay), or between S-GW and P-GW (Packet data network GateWay). Additionally, AME has mapping data by sharing information about RNC-ID or eNB-ID and information between AMEs.

AME may perform the following functions. The first function is to monitor an application being used by user equipment by intercepting user data-plane and control-plane at IuPS and S1 interface. The second function is to detect the handover operation of user equipment. The third function is to form a logical interface between AMEs by checking information about a target eNB and associated AME on the basis of mapping data when the handover operation of user equipment is detected. The fourth function is to perform data transmission between AME and user equipment before handover using such an interface between AMEs.

### DISCLOSURE

### Technical Problem

AME is located between respective elements in a mobile communication network and performs an operation of intercepting data by monitoring user data-plane and control-plane. Namely, AME repeats a function performed by EPC and eNB. Unfortunately, this causes a GTP packet decoding and encoding process to be performed twice, thus incurring a data latency delay. Further, the repetition of unnecessary step invites inefficiency in a processing procedure. Accordingly, the present invention is to propose a mobile communication system and a method for providing contents in case of handover in the mobile communication system.

### Technical Solution

In order to solve the above problems, in the present invention, a method for providing contents includes, when a request message for providing content is received from UE (User Equipment), step of allowing a source eNB (enhanced Node B) to check whether the content is stored in a cache thereof, and therefore to transmit the content to the UE; when a handover request message is received from the UE, step of allowing the source eNB to transmit a content confirmation request message, which requests confirmation of whether the content is stored in a cache, to a target eNB to which the UE is to be handed over; step of allowing the target eNB to determine whether the content is stored in a cache thereof, and then to transmit a result of determination to the source eNB; and when handover is completed, step of allowing the target eNB to transmit the content to the UE, depending on the result of determination.

Additionally, in order to solve the above problems, in the present invention, a mobile communication system includes a source eNB (enhanced Node B) that is configured to, when a request message for providing content is received from UE (User Equipment), check whether the content is stored in a cache thereof, and therefore transmit the content to the UE, and further configured to, when a handover request message is received from the UE, transmit a content confirmation request message, which requests confirmation of whether the content is stored in a cache, to a target eNB to which the UE is to be handed over; and the target eNB that is configured to determine whether the content is stored in a cache thereof, and then to transmit a result of determination to the source eNB, and further configured to, when handover is completed, transmit the content to the UE, depending on the result of determination.

### Advantageous Effects

According to the present invention, a source eNB can provide contents seamlessly to user equipment by transmitting session information and contents to a target eNB in case of handover through a logical interface between eNBs in the LTE system. Also, this invention may apply a cache function to eNB, reduce backhaul cost due to handover, and enhance user-experienced quality.

### DESCRIPTION OF DRAWINGS

FIG. 1 is a diagram illustrating the configuration of a mobile communication system in accordance with the present invention.

FIG. 2 is a diagram illustrating a signal flow of a method for providing contents in a mobile communication system in accordance with the first embodiment of the present invention.

FIG. 3 is a diagram illustrating a signal flow of a method for providing contents in a mobile communication system in accordance with the second embodiment of the present invention.

FIG. 4 is a diagram illustrating a signal flow of a method for providing contents in a mobile communication system in accordance with the third embodiment of the present invention.

FIG. 5 is a diagram illustrating a signal flow of a method for providing contents in a mobile communication system in accordance with the fourth embodiment of the present invention.

FIG. 6 is a diagram illustrating a flow of providing contents in accordance with the second embodiment of the present invention.

FIG. 7 is a diagram illustrating a flow of providing contents in accordance with the third embodiment of the present invention.

FIG. 8 is a diagram illustrating a flow of providing contents in accordance with the fourth embodiment of the present invention.

### MODE FOR INVENTION

Hereinafter, the operation principles of the present invention will be fully described with reference to the accompanying drawings. In the following description, well known functions or configurations may not be described or illustrated in detail to avoid obscuring the essence of the present invention. The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

Although herein a mobile communication system of the present invention is described on the basis of elements constituting the LTE (Long Term Evolution) communication system, this is exemplary only and not to be considered as a limitation of the invention. Alternatively, the present invention may be applied to elements that constitute any other communication system based on 2G, 3G or 3.5G such as CDMA (Code Division Multiple Access), WCDMA (Wideband Code Division Multiple Access), GSM (Global System for Mobile communication), UMTS (Universal Mobile Telecommunication System), WiMAX (Worldwide Interoperability for Microwave Access), and HSPDA (High Speed Downlink Packet Access).

EPC (Evolved Packet Core) includes an access gateway that performs a function of access service between IP-based wired and wireless networks, a function of packet routing and forwarding, and a function of gateway for a connection with any external PDN. Further, EPC includes MME (Mobility Management Entity) that manages the mobility of UE (User Equipment), authentication, bearer, session, etc. and also performs an NAS (Non-Access Stratum) signaling control or the like.

A source eNB (enhanced Node B) means eNB that offers currently a service to UE, and a target eNB means eNB as destination of handover or eNB to be registered by UE at the last step of handover.

Data means all kinds of data processed in a mobile communication system, including commands, request messages, and contents transmitted or received between respective elements.

Content means all kinds of data allowing UE to process, including voice data, text data, video data, image data, web pages or documents, and the like.

A cache means a dedicated, small-sized, high-speed memory unit used for enhancing the performance of UE or a part of a main memory unit used for the same purpose. The cache offers a memory space for temporarily storing contents and commands between a control unit and a main memory unit having a lower speed than the control unit, thus allowing the control unit to quickly access the main memory unit. For this, when the control unit accesses the main memory unit and then reads or writes contents, a copy thereof, together with the address of the main memory unit, is stored in the cache. According as the cache has greater memory capacity, the performance of UE is enhanced since there is a high probability that required contents have been already stored.

When the control unit refers to the address of the main memory unit in order to call specific content, the cache checks whether the address is stored therein. If the address is stored in the cache, the cache transmits the specific content to the control unit. If the address is not stored in the cache, the cache retrieves the specific content from the main memory, transmits the retrieved content to the control unit, and also stores the retrieved content therein. Additionally, the cache predicts in advance, through a prediction algorithm, any data or command required for the control unit to execute the next command or program, retrieves such data from the main memory unit, and stores it therein. Therefore, the cache can reduce time required for reading content, the control unit needs, from the main memory unit.

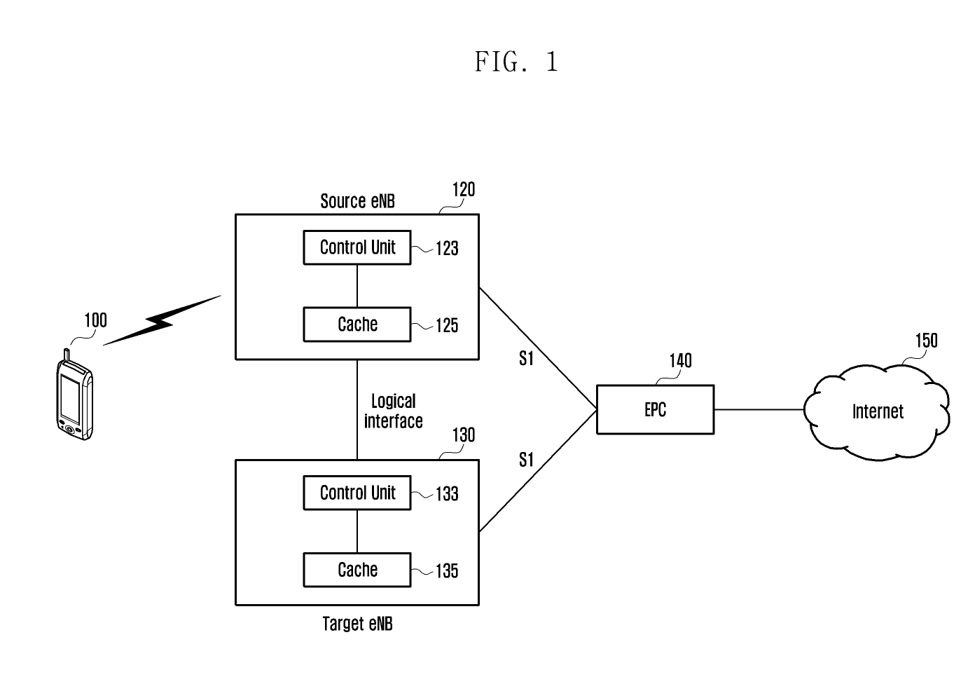

FIG. 1 is a diagram illustrating the configuration of a mobile communication system in accordance with the present invention.

Referring to FIG. 1, the mobile communication system is composed of UE (User Equipment) 100, a source eNB (enhanced Node B) 120, a target eNB 130, EPC 140, and an internet 150.

The UE 100 receives user-desired content through the source eNB 120 connected currently. After handover, the target eNB 130 may continuously offer such content the UE 100 has been receiving from the source eNB 120. The EPC 140 performs a gateway function for connecting each of the source eNB 120 and the target eNB 130 to the internet 150. The internet 150 may offer requested content to the UE 100 through the source eNB 120 and the target eNB 130. Here, the source eNB 120 and the target eNB 130 may transmit contents and information about the UE 100 for handover through a logical interface. Also, the source eNB 120 and the target eNB 130 may receive contents from the EPC 140 through an S1 interface.

Each of the source eNB 120 and the target eNB 130 is composed of a control unit 123 or 133 and a cache 125 or 135. The control unit 123 or 133 controls the operation and status of all elements constituting each of the source eNB 120 and the target eNB 130. Here, the control unit 123 or 133 performs a function of handover and call connection/disconnection for the UE 100. The cache 125 or 135 stores contents and performs a function as a content server that transmits specific content requested by the UE 100 under the control of the control unit 123 or 133. Although not shown in the drawings, each of the source eNB 120 and the target eNB 130 further includes PDCP (Packet Data Convergence Protocol) and GTP (GPRS Tunneling Protocol). PDCP and GTP are content transmission protocols. PDCP performs a function to transmit contents to the UE 100, and GTP performs a function to transmit data to the EPC 140.

According to this invention, when a content request message is received from the UE, the source eNB determines whether specific content requested by the UE is stored in the cache. If the requested content is stored in the cache, the source eNB transmits immediately the stored content to the UE. In contrast, if the requested content is not stored in the cache, the source eNB requests such content from the internet or the like. If the requested content is received from the internet or the like, the source eNB transmits the received content to the UE. At this time, the source eNB stores such content in the cache.

Additionally, in case of handover of the UE from the source eNB to the target eNB, the source eNB transmits a content confirmation request message, as well as a handover command message, for requesting confirmation of whether specific content offered currently to the UE is stored in the cache of the target eNB. In response to the content confirmation request message received, the target eNB determines whether the specific content is stored in the cache thereof. Then the target eNB transmits the result of determination, together with a response message in reply to a handover command, to the source eNB.

Next, the target eNB offers, to the UE, specific content checked depending on whether stored or not. Specifically, the target eNB offers, to the UE, content received through the source eNB or the internet or content stored therein. At this time, the target eNB offers content by using context information which is received from the source eNB and contains information about specific content offered to the UE. Therefore, the target eNB can transmit contents seamlessly to the UE even after handover.

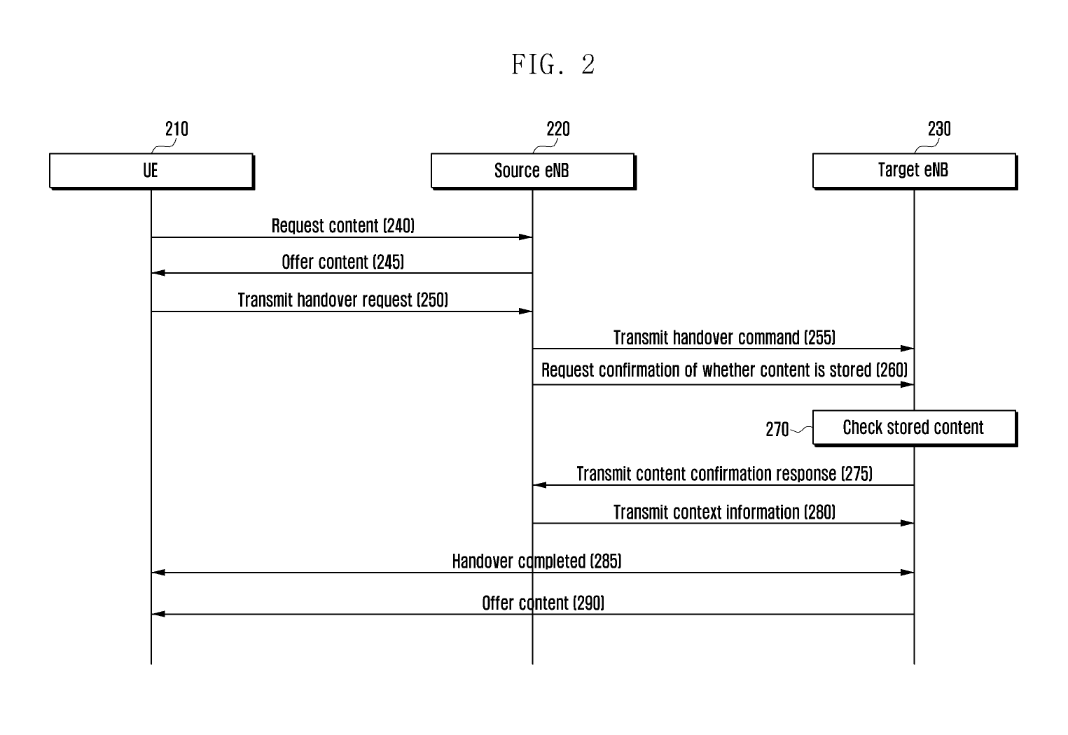

Now, a process for providing content in case of handover of UE in a mobile communication system will be described with reference to FIGS. 2 to 8, depending on where such content is stored. The following description will be focused on a case of providing contents stored in the target eNB, a case of providing contents through the source eNB, and a case of providing contents through the internet.

FIG. 2 is a diagram illustrating a signal flow of a method for providing contents in a mobile communication system in accordance with the first embodiment of the present invention.

Referring to FIG. 2, in the mobile communication system composed of UE 210, a source eNB 220, and a target eNB 230, the UE 210 sends a request for content to the connected source eNB 220 at step 240. Then, at step 245, the source eNB 220 identifies contents stored in a cache thereof and offers specific content requested by the UE 210. Thereafter, the UE 210 periodically checks the strength of signals received from the source eNB 220.

If the strength of received signals is smaller than a predefined handover threshold, the UE 210 transmits a handover request message to the source eNB 220 at step 250. Then the source eNB 220 transmits a handover command message to the target eNB 230 at step 255. Further, the source eNB 220 transmits a content confirmation request message to the target eNB 230 at step 260. The content confirmation request message means a message for requesting confirmation of whether specific content offered to the UE by the source eNB 220 is stored in the target eNB 230.

At step 270, the target eNB 230 checks whether the specific content is stored in a cache thereof. If the specific content is stored in the cache, the target eNB 230 transmits at step 275 a content confirmation response message indicating that there is stored content, together with a response message in reply to a handover request, to the source eNB 220. Then the source eNB 220 transmits context information to the target eNB 230 at step 280. Here, the context information contains an end marker which indicates a time point of content that should be transmitted from the target eNB 230. The end marker contains information about the amount of contents offered to the UE 210 by the source eNB 220 until a time point of handover, and information about a time point when the target eNB 230 will offer contents to the UE 210. Specifically, a control unit and a cache of the source eNB 220 transmit such context information to a control unit and a cache of the target eNB 230, respectively.

When handover between the UE 210 and the target eNB 230 is completed at step 285, the target eNB 230 offers at step 290 specific content stored in the cache thereof to the UE 210 according to the received context information. Therefore, the UE 210 can receive seamlessly, through the target eNB 230, contents that have been received from the source eNB 220.

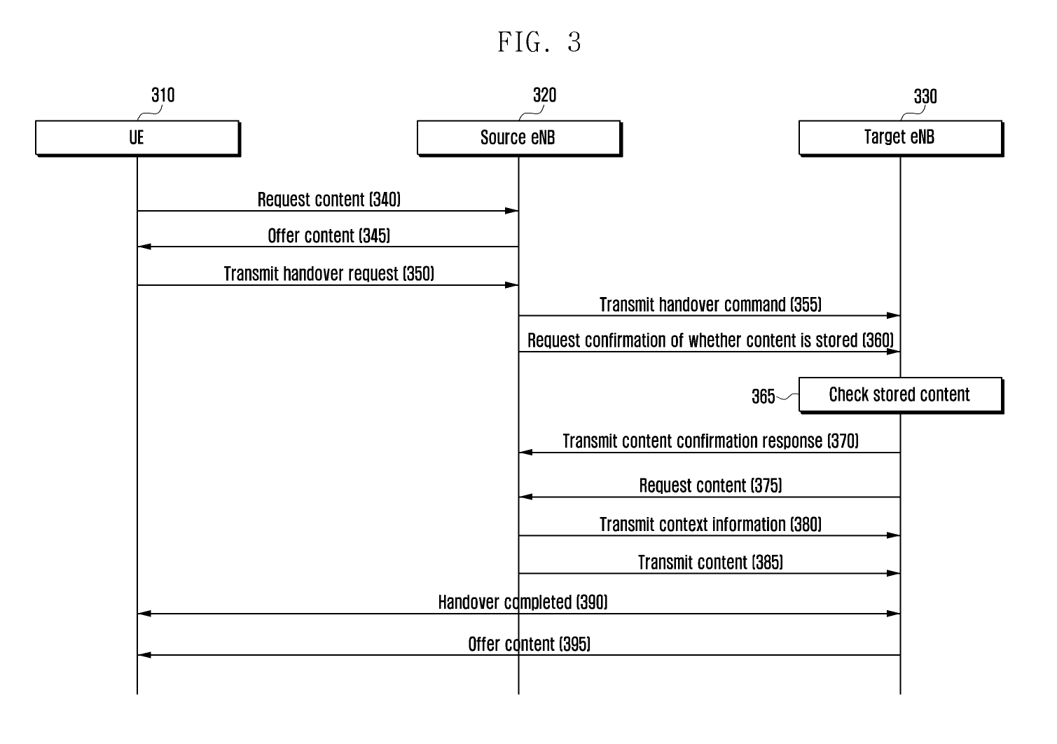

FIG. 3 is a diagram illustrating a signal flow of a method for providing contents in a mobile communication system in accordance with the second embodiment of the present invention.

Referring to FIG. 3, in the mobile communication system composed of UE 310, a source eNB 320, and a target eNB 330, the UE 310 sends a request for content to the connected source eNB 320 at step 340. Then, at step 345, the source eNB 320 identifies contents stored in a cache thereof and offers specific content requested by the UE 310. Thereafter, the UE 310 periodically checks the strength of signals received from the source eNB 320.

If the strength of received signals is smaller than a predefined handover threshold, the UE 310 transmits a handover request message to the source eNB 320 at step 350. Then the source eNB 320 transmits a handover command message to the target eNB 330 at step 355. Further, the source eNB 320 transmits a content confirmation request message to the target eNB 330 at step 360. The content confirmation request message means a message for requesting confirmation of whether specific content offered to the UE by the source eNB 320 is stored in the target eNB 330. Although it is herein described that the handover command message and the content confirmation request message are transmitted separately, this is exemplary only and not to be considered as a limitation. Alternatively, both messages may be transmitted in the form of a single message.

At step 365, the target eNB 330 checks whether the specific content is stored in a cache thereof. If the specific content is not stored in the cache, the target eNB 330 transmits at step 370 a content confirmation response message indicating that there is no stored content, together with a response message in reply to a handover request, to the source eNB 320. Further, at step 375, the target eNB 330 transmits, to the source eNB 320, a content request message for requesting the specific content.

Then the source eNB 320 transmits context information to the target eNB 330 at step 380. Here, the context information contains an end marker which indicates a time point of content that should be transmitted from the target eNB 330. The end marker contains information about the amount of contents offered to the UE 310 by the source eNB 320 until a time point of handover, and information about a time point when the target eNB 330 will offer contents to the UE 310. Further, at step 385, the source eNB 320 transmits content requested by the target eNB 330. Specifically, a control unit of the source eNB 320 transmits the context information to a control unit of the target eNB 330, and a cache of the source eNB 320 transmits the requested content to the target eNB 330.

Although it is herein described that the context information and the requested content are transmitted separately, this is exemplary only and not to be considered as a limitation. Alternatively, the source eNB 320 may transmit the context information, together with the content, to the target eNB 330. Additionally, such content may be transmitted through a logical interface between the source eNB 320 and the target eNB 330.

When handover between the UE 310 and the target eNB 330 is completed at step 390, the target eNB 330 offers at step 395 specific content stored in the cache thereof to the UE 310 according to the received context information. Therefore, the UE 310 can receive seamlessly, through the target eNB 330, contents that have been received from the source eNB 320.

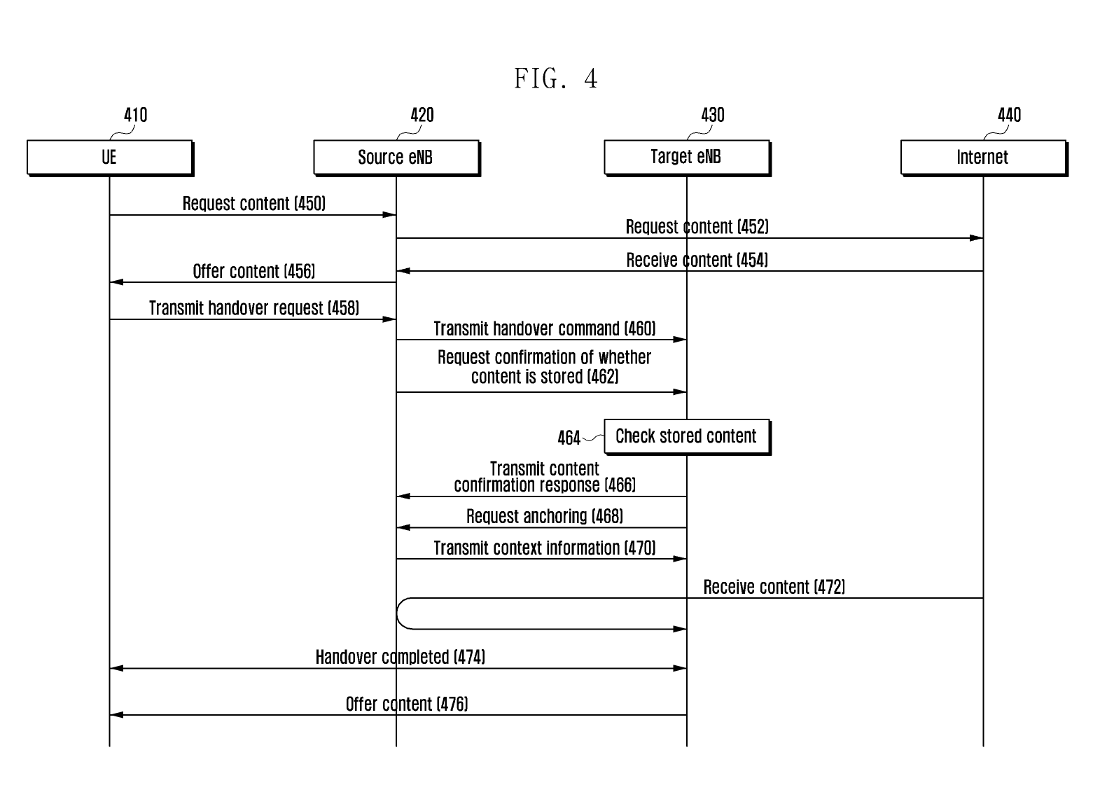

FIG. 4 is a diagram illustrating a signal flow of a method for providing contents in a mobile communication system in accordance with the third embodiment of the present invention.

Referring to FIG. 4, in the mobile communication system composed of UE 410, a source eNB 420, a target eNB 430, and an internet 440, the UE 410 sends a request for content to the connected source eNB 320 at step 450. Then the source eNB 420 checks whether specific content requested by the UE 410 is stored in a cache thereof. Although not shown, it is supposed that the internet 540 includes EPC therein.

If the requested content is not stored, the source eNB 420 sends a request for content to the internet 440 at step 452. Then the source eNB 420 receives the content from the internet 440 at step 454. Next, at step 456, the source eNB 420 offers the requested content to the UE 410. Thereafter, the UE 410 periodically checks the strength of signals received from the source eNB 420.

If the strength of received signals is smaller than a predefined handover threshold, the UE 410 transmits a handover request message to the source eNB 420 at step 458. Then the source eNB 420 transmits a handover command message to the target eNB 430 at step 460. Further, the source eNB 420 transmits a content confirmation request message to the target eNB 430 at step 462. The content confirmation request message means a message for requesting confirmation of whether specific content offered to the UE by the source eNB 420 is stored in the target eNB 430. Although it is herein described that the handover command message and the content confirmation request message are transmitted separately, this is exemplary only and not to be considered as a limitation. Alternatively, both messages may be transmitted in the form of a single message.

At step 464, the target eNB 430 checks whether the specific content is stored in a cache thereof. If the specific content is not stored in the cache, the target eNB 430 transmits at step 466 a content confirmation response message indicating that there is no stored content, together with a response message in reply to a handover request, to the source eNB 420. Further, at step 468, the target eNB 430 transmits, to the source eNB 420, an anchoring request message which is a content request message for requesting the specific content.

Then the source eNB 420 transmits context information to the target eNB 430 at step 470. Here, the context information contains an end marker which indicates a time point of content that should be transmitted from the target eNB 430. Although it is herein described that the context information and the requested content are transmitted separately, this is exemplary only and not to be considered as a limitation. Alternatively, the source eNB 420 may transmit the context information, together with the content, to the target eNB 430.

At step 472, the target eNB 430 receives specific content from the internet 440 through the source eNB 420. Namely, a TCP/UDP connection is maintained between the source eNB 420 and the internet 440, and the content is transmitted to the target eNB 430. At this time, a TCP session is maintained between a cache of the source eNB 420 and the UE 410, and the content is transmitted. In this case, without passing through a cache of the target eNB 430, the content is transmitted to the UE 410 through PDCP of the target eNB 430.

When handover between the UE 410 and the target eNB 430 is completed at step 474, the target eNB 430 offers at step 476 the content requested by the UE 410. In this case, when the transmission of content to have been offered to the UE 410 through the source eNB 420 is completed, new content requested by the UE 410 is transmitted through a TCP/UDP session created between a cache of the target eNB 430 and the UE 410.

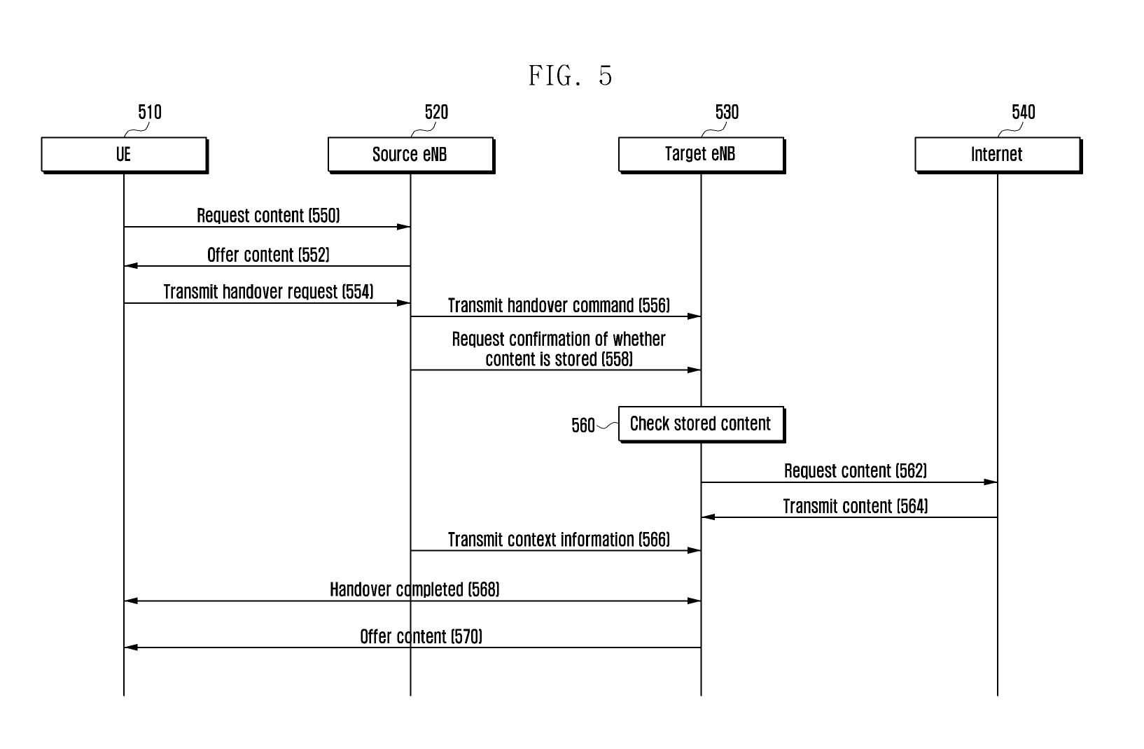

FIG. 5 is a diagram illustrating a signal flow of a method for providing contents in a mobile communication system in accordance with the fourth embodiment of the present invention.

Referring to FIG. 5, in the mobile communication system composed of UE 510, a source eNB 520, a target eNB 530, and an internet 540, the UE 510 sends a request for content to the connected source eNB 520 at step 550. Although not shown, it is supposed that the internet 540 includes EPC therein.

At step 552, the source eNB 520 determines whether the requested content is stored in a cache thereof, and then offers the stored content to the UE 510. Thereafter, the UE 510 periodically checks the strength of signals received from the source eNB 520.

If the strength of received signals is smaller than a predefined handover threshold, the UE 510 transmits a handover request message to the source eNB 520 at step 554. Then the source eNB 520 transmits a handover command message to the target eNB 530 at step 556. Further, the source eNB 520 transmits a content confirmation request message to the target eNB 530 at step 558. The content confirmation request message means a message for requesting confirmation of whether specific content offered to the UE by the source eNB 520 is stored in the target eNB 530. Although it is herein described that the handover command message and the content confirmation request message are transmitted separately, this is exemplary only and not to be considered as a limitation. Alternatively, both messages may be transmitted in the form of a single message.

At step 560, the target eNB 530 checks whether the specific content is stored in a cache thereof. If the specific content is not stored in the cache, the target eNB 530 transmits at step 562 a message for requesting the content to the internet 540. Then the internet 540 transmits the requested content to the target eNB 530 at step 564. Then the target eNB 530 stores the received content in a cache thereof.

Although not shown, the target eNB 530 transmits a content confirmation response message, together with a response message in reply to a handover request, to the source eNB 520. Then the source eNB 520 transmits context information to the target eNB 530 at step 566. Here, the context information contains an end marker which indicates a time point of content that should be transmitted from the target eNB 530. Although it is herein described that the context information and the requested content are transmitted separately, this is exemplary only and not to be considered as a limitation. Alternatively, the source eNB 520 may transmit the context information, together with the content, to the target eNB 530.

When handover between the UE 510 and the target eNB 530 is completed at step 568, the target eNB 530 offers at step 570 the content requested by the UE 510. In this case, since a TCP/UDP session between the source eNB and the UE is transmitted to the target eNB, the target eNB can continuously transmit contents to the UE.

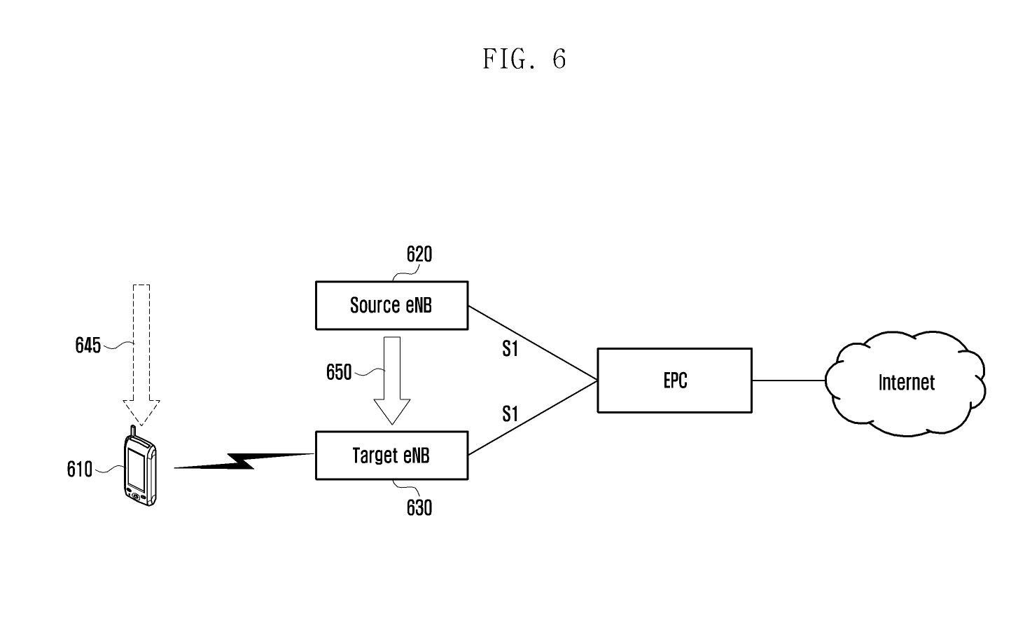

FIG. 6 is a diagram illustrating a flow of providing contents in accordance with the second embodiment of the present invention.

Referring to FIG. 6, as indicated by 645, handover of UE 610 takes place from a source eNB 620 to a target eNB 630. The target eNB 620 checks whether specific content having been offered to the UE 610 by the source eNB 620 is stored therein. If the content is not stored, the target eNB 630 sends a request for the content to the source eNB 620. If the content offered to the UE 610 is stored in the source eNB 620, the source eNB 620 transmits the content to the target eNB 630 as indicated by 650.

The target eNB 630 offers, to the UE 610, the content received from the source eNB 620. At this time, using context information transmitted from the source eNB 620, the target eNB 630 identifies contents offered to the UE 610 by the source eNB 620. Further, the target eNB 630 offers, to the UE 610, all but contents having been already transmitted. Namely, contents are transmitted from the source eNB 620 to the target eNB 630 and then offered to the UE 610. Such contents are transmitted through a logical interface between the source eNB 320 and the target eNB 330.

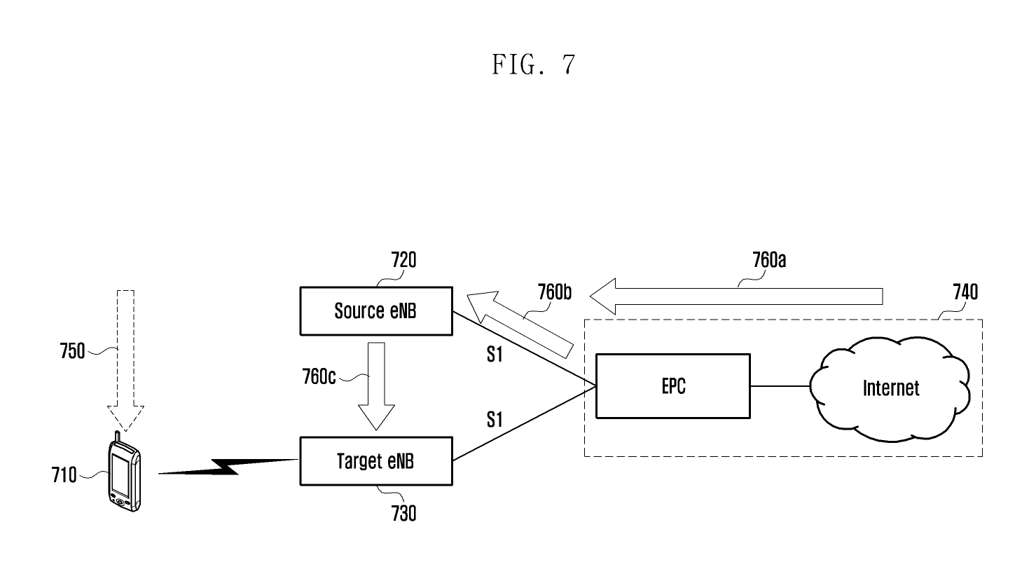

FIG. 7 is a diagram illustrating a flow of providing contents in accordance with the third embodiment of the present invention.

Referring to FIG. 7, as indicated by 750, handover of UE 710 takes place from a source eNB 720 to a target eNB 730. The target eNB 730 checks whether specific content having been offered to the UE 710 by the source eNB 720 is stored therein. If the content is not stored, the target eNB 730 sends a request for the content to the source eNB 720. If the content offered to the UE 710 has been offered through an internet 740 rather than the source eNB 720, the source eNB 720 transmits, to the target eNB 730, the content offered through the internet 740 as indicated by 760a, 760b and 760c.

Then the target eNB 730 offers, to the UE 710, the content received from the source eNB 720. At this time, using context information transmitted from the source eNB 720, the target eNB 730 checks the amount of contents offered to the UE 710. Further, the target eNB 730 offers, to the UE 710, all contents except the checked amount thereof. In this case, contents transmitted through the internet 740 are transmitted from the source eNB 720 to the target eNB 730 and then offered to the UE 710.

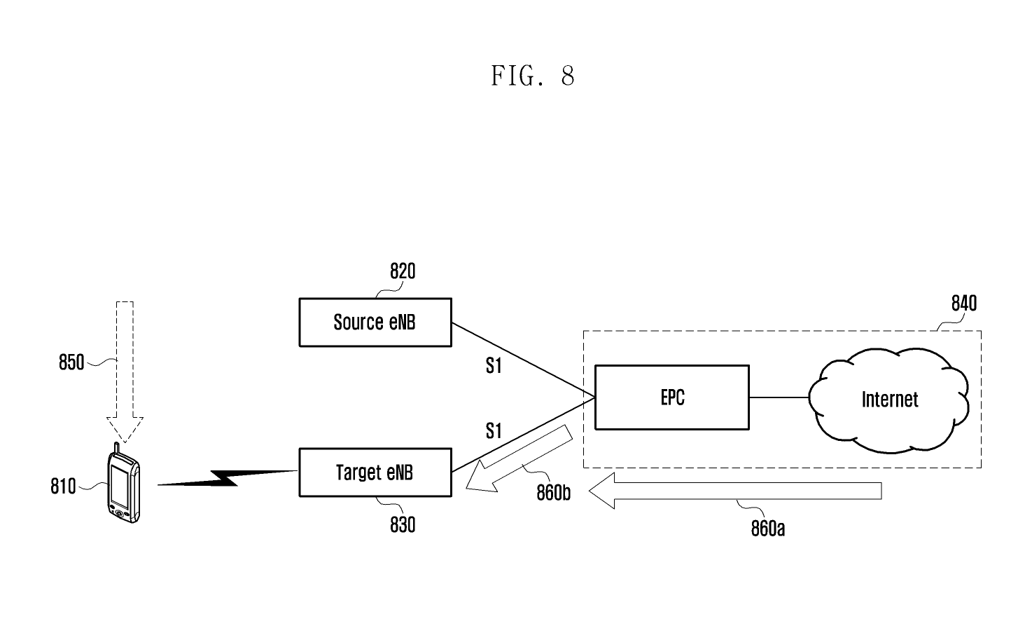

FIG. 8 is a diagram illustrating a flow of providing contents in accordance with the fourth embodiment of the present invention.

Referring to FIG. 8, as indicated by 850, handover of UE 810 takes place from a source eNB 820 to a target eNB 830. The target eNB 830 checks whether specific content having been offered to the UE 810 by the source eNB 820 is stored therein. If the content is not stored, the target eNB 730 sends a request for the content to an internet 840. The internet 840 transmits the content to the target eNB 830 as indicated by 860a and 860b. Then the target eNB 830 offers, to the UE 810, the content received from the internet 840. At this time, using context information transmitted from the source eNB 820, the target eNB 830 checks the amount of contents offered to the UE 810. Further, the target eNB 830 offers, to the UE 810, all contents except the checked amount thereof. In this case, contents transmitted through the internet 840 are transmitted to the target eNB 830 and then offered to the UE 810.

Through the above-discussed process, this invention uses a logical interface between eNBs in the LTE system, and in case of handover of UE, can offer contents seamlessly to the UE by allowing the source eNB to transmit session information and contents to the target eNB.

While the present invention has been particularly shown and described with reference to an exemplary embodiment thereof, it will be understood by those skilled in the art that various changes in form and details may be made therein without departing from the spirit and scope of this invention as defined by the appended claims.

1. A handover method at a source eNB (enhanced Node B) of a mobile communication system, the method comprising steps of:
in case a request message for providing content is received from UE (User Equipment), checking whether the content is stored in a cache thereof, and therefore transmitting the content to the UE;
in case a handover request message is received from the UE, transmitting a content confirmation request message, which requests confirmation of whether the content is stored in a cache, to a target eNB to which the UE is to be handed over; and
in case a content confirmation response message is received from the target eNB, transmitting context information, which is information about contents offered to the UE, to the target eNB.

2. The method of claim 1, wherein the step of transmitting the context information to the target eNB includes step of:
in case a content confirmation response message, which indicates that the content is not stored, is received from the target eNB, transmitting the content, together with the context information, to the target eNB.

3. The method of claim 2, wherein the step of transmitting the content, together with the context information, to the target eNB includes steps of:
receiving the content from an internet; and
transmitting the received content to the target eNB.

4. The method of claim 1, wherein the step of transmitting the content to the UE includes steps of:
in case the content is not stored, sending a request for the content to an internet; and
transmitting, to the UE, the content received from the internet.

5. The method of claim 1, wherein the step of transmitting the context information to the target eNB includes step of:
when the content confirmation response message is received from the target eNB, receiving a response message in reply to the handover request message, together with a result of determining whether the content is stored.

6. A handover method at a target eNB (enhanced Node B) of a mobile communication system, the method comprising steps of:
receiving a content confirmation request message from a source eNB;
determining whether requested content is stored in a cache thereof, and then transmitting a content confirmation response message which indicates a result of determination;
receiving context information which is information about contents offered to UE (User Equipment); and
transmitting the content to the UE, depending on the result of determination.

7. The method of claim 6, wherein the step of transmitting the content to the UE includes step of:
in case the content is stored in the cache, transmitting the content to the UE according to the context information.

8. The method of claim 6, wherein the step of transmitting the content to the UE includes steps of:
transmitting, to the source eNB, a content request message for requesting the content;
receiving the content from the source eNB; and
transmitting the content to the UE according to the context information.

9. The method of claim 8, wherein the step of receiving the content from the source eNB includes step of:
receiving content received from an internet by the source eNB.

10. The method of claim 6, wherein the step of transmitting the content to the UE includes steps of:
receiving the content from an internet by sending a request for the content to the internet; and
transmitting the content to the UE according to the context information.

11. The method of claim 6, wherein the step of transmitting the content confirmation response message includes step of:
transmitting a response message in reply to a handover request, together with the result of determination.

12. A source eNB (enhanced Node B) performing handover in a mobile communication system, the source eNB comprising:
a cache configured to store contents therein; and
a control unit configured to, in case a request message for providing content is received from UE (User Equipment), check whether the content is stored in a cache thereof, and therefore transmit the content to the UE, further configured to, in case a handover request message is received from the UE, transmit a content confirmation request message, which requests confirmation of whether the content is stored in a cache, to a target eNB to which the UE is to be handed over, and further configured to, in case a content confirmation response message is received from the target eNB, transmit context information, which is information about contents offered to the UE, to the target eNB.

13. The source eNB of claim 12, wherein the control unit is further configured to, when the context information is transmitted to the target eNB, in case a content confirmation response message, which indicates that the content is not stored, is received from the target eNB, transmit the content, together with the context information, to the target eNB.

14. A target eNB (enhanced Node B) performing handover in a mobile communication system, the target eNB comprising:
a cache configured to store contents therein; and
a control unit configured to receive a content confirmation request message from a source eNB, to determine whether requested content is stored in a cache thereof, and then transmit a content confirmation response message which indicates a result of determination, to receive context information which is information about contents offered to UE (User Equipment), and to transmit the content to the UE, depending on the result of determination.

15. The target eNB of claim 14, wherein the control unit is further configured to, when the content is transmitted to the UE, in case the content is stored in the cache, transmit the content to the UE according to the context information.
